(19) United States
(12) Patent Application Publication
(10) Pub. No.: US 2024/0346248 A1
(43) Pub. Date: Oct. 17, 2024

(54) SOURCE CODE DOCUMENTATION DEHYDRATOR

(71) Applicant: Oracle International Corporation, Redwood Shores, CA (US)

(72) Inventors: Pavel Rappo, Dun Laoghaire (IE); Joseph D. Darcy, Redwood City, CA (US); Jonathan J. Gibbons, Mountain View, CA (US)

(73) Assignee: Oracle International Corporation, Redwood Shores, CA (US)

(21) Appl. No.: 18/301,814

(22) Filed: Apr. 17, 2023

(51) Int. Cl. G06F 40/284; G06F 8/73; G06F 40/16; G06F 40/216

(52) U.S. Cl. CPC G06F 40/284; G06F 8/73; G06F 40/16; G06F 40/216

(57) ABSTRACT

Techniques for dehydrating hierarchical source code documentation are disclosed, including: obtaining (a) a first set of documentation associated with a first element of source code and (b) a second set of documentation associated with a second element of source code that inherits functionality from the first element of source code; identifying a repeated segment of text in the first set of documentation and the second set of documentation; assigning a token to the repeated segment of text in the first set of documentation; replacing the repeated segment of text in the second set of documentation with the token, such that when presenting the second set of documentation, the token is replaced with the repeated segment of text.

### TECHNICAL FIELD

The present disclosure relates to computer programming. In particular, the present disclosure relates to documenting source code in computer programming.

### BACKGROUND

Source code (sometimes referred to simply as “code”) is a set of instructions that are written in a computer programming language. A compiler or interpreter receives source code as input and translates it into a language (e.g., bytecode or a natively executable file) that the computer can understand and execute. Source code may be written in any programming language, such as C++, Java, or Python. Source code documentation is text that describes what an element of code (e.g., a module, package, class, interface, constructor, method, field, etc.) does and how it works. For example, source code documentation may explain the purpose of the code, its function(s), and/or why a particular programming approach was taken.

Different systems exist for generating source code documentation. For example, JavaDoc is a tool for generating API documentation, in hypertext markup language (HTML) and/or another format, from documentation comments in source code written in the Java programming language. JavaDoc may be used to generate documentation that describes the modules, packages, classes, interfaces, constructors, methods, fields, etc. of a Java library.

Documentation of hierarchical source code often repeats segments of text in different locations. For example, in Java, the specification for a method foo( ) in class A may include a general description of foo( ) s functionality. Class B may be a subclass of A and override foo( ) The documentation of foo( ) in B may repeat the general text of A's foo( ) documentation and add some B-specific text. Ensuring the consistency of such repeated text on an ongoing basis is a maintenance burden. In a typical approach, a programmer or documentation specialist must update documentation manually on a class-by-class, method-by-method, line-by-line basis. Human errors in this process can result in documentation that is inaccurate and/or inconsistent between different subsets of an overall code base, and the risk of such errors increases as the code base grows and changes over time.

In addition to the maintenance burden, repetitive documentation can degrade overall system performance. Repetitive documentation consumes storage space that could otherwise be used for other resources (e.g., the source code itself and/or other assets used by the software program). Repetitive documentation may also incur other kinds of computing costs, such as additional bandwidth needed to transmit the documented code between systems. In general, repetitive documentation implicates various computing costs associated with repetitive and redundant data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and mean at least one. In the drawings:

FIG. 1 shows a block diagram that illustrates an example of a system in accordance with one or more embodiments;

FIGS. 2A-2C illustrate an example set of operations for dehydrating hierarchical source code documentation in accordance with one or more embodiments;

FIG. 3 illustrates an example of dehydrating hierarchical source code documentation in accordance with one or more embodiments; and

FIG. 4 shows a block diagram that illustrates a computer system in accordance with one or more embodiments.

### DETAILED DESCRIPTION

In the following description, for the purposes of explanation and to provide a thorough understanding, numerous specific details are set forth. One or more embodiments may be practiced without these specific details. Features described in one embodiment may be combined with features described in a different embodiment. In some examples, well-known structures and devices are described with reference to a block diagram form, in order to avoid unnecessarily obscuring the present invention.

The following table of contents is provided for reference purposes only and should not be construed as limiting the scope of one or more embodiments.

| | |
|---|---|
| 1. | GENERAL OVERVIEW |
| 2. | EXAMPLE SYSTEM |
| | 2.1. SYSTEM COMPONENTS |
| | 2.2. DATA STORAGE |
| | 2.3. USER INTERFACE |
| | 2.4. TENANTS |
| | 2.5. MACHINE LEARNING |
| 3. | DEHYDRATING HIERARCHICAL SOURCE CODE |
| | DOCUMENTATION |
| | 3.1. TRAINING A MACHINE LEARNING MODEL TO DETECT |
| | SIMILARITIES IN SOURCE CODE DOCUMENTATION |
| | 3.2. DEHYDRATING EXISTING DOCUMENTATION |
| | 3.2.1. CONTEXT-SPECIFIC VALUES |
| | 3.2.1. SIMILAR TEXT SEGMENTS |
| | 3.2.1.1. UNEXPECTEDLY LOW SIMILARITY SCORE |
| | 3.2.1.2. UNCERTAIN SIMILARITY SCORE |
| | 3.2.1.3. HIGH SIMILARITY SCORE |
| | 3.2.1.4. REDUCING SIMILAR TEXT |
| | 3.3. PRESENTING DOCUMENTATION |
| | 3.4. UPDATING THE MACHINE LEARNING MODEL |
| 4. | EXAMPLE EMBODIMENT |
| 5. | COMPUTER NETWORKS AND CLOUD NETWORKS |
| 6. | MICROSERVICE APPLICATIONS |
| | 6.1. TRIGGERS |
| | 6.2. ACTIONS |
| 7. | HARDWARE OVERVIEW |
| 8. | MISCELLANEOUS; EXTENSIONS |

### 1. GENERAL OVERVIEW

One or more embodiments reduce redundancies across source code documentation associated with different elements of code. This process is referred to herein as “dehydration,” which refers generally to the process of removing unnecessary (in this case, redundant) data from a file or dataset. Dehydration allows for the creation of smaller, more efficient documentation that is easier to store and manipulate. Removing unnecessary data makes the remaining documentation easier to analyze and process. Dehydration can be used to reduce the size of large sets of documentation, reduce memory and storage requirements, and speed up processing times.

One or more embodiments dehydrate source code documentation by identifying repeated segments of text across different sets of documentation associated with elements of code in hierarchical parent/child relationships (e.g., classes that extend other classes, classes that implement interfaces, etc.). A code element that inherits functionality from another code element is referred to herein as the “child code element,” and the other code element is referred to as the “parent code element.” Some child code elements may have multiple parent code elements; for example, a class may implement multiple interfaces. When documentation is repeated across parent and child elements, the repeated segment of text is replaced with a token that references that same segment of text in the parent element. Thus, the redundancy is eliminated and the token typically consumes less space than the repeated text. This approach also allows for changes to the parent element's documentation to propagate through any child element documentation that references the parent element's documentation. In an embodiment, dehydration may operate across multiple levels of code element hierarchy; one element may inherit documentation from another element, which in turn inherits its documentation from yet another element, etc. Thus, one or more embodiments can dehydrate complex, multi-level hierarchies of source code documentation.

One or more embodiments further dehydrate source code documentation by replacing context-specific values (e.g., module names, package names, class names, interface names, constructor names, method names, field names, etc.) with corresponding tokens. If the token is smaller (e.g., fewer characters) than the replaced value, this approach can consume less space. In addition, this approach provides resiliency against code changes—for example, helping to avoid a scenario where a class name changes but the documentation still refers to the old class name. The two kinds of tokens may be combined, so that a parent element's documentation includes a token for a context-specific value that resolves differently for each child element that inherits the parent element's documentation.

Approaches described herein are easier to maintain than purely manual approaches, and can improve system performance by requiring less storage, bandwidth, etc. Thus, one or more embodiments overcome the technical challenges of (1) keeping source code documentation accurate and consistent and (2) reducing the performance impacts associated with storing redundant data.

One or more embodiments described in this Specification and/or recited in the claims may not be included in this General Overview section.

### 2. EXAMPLE SYSTEM

### 2.1. System Components

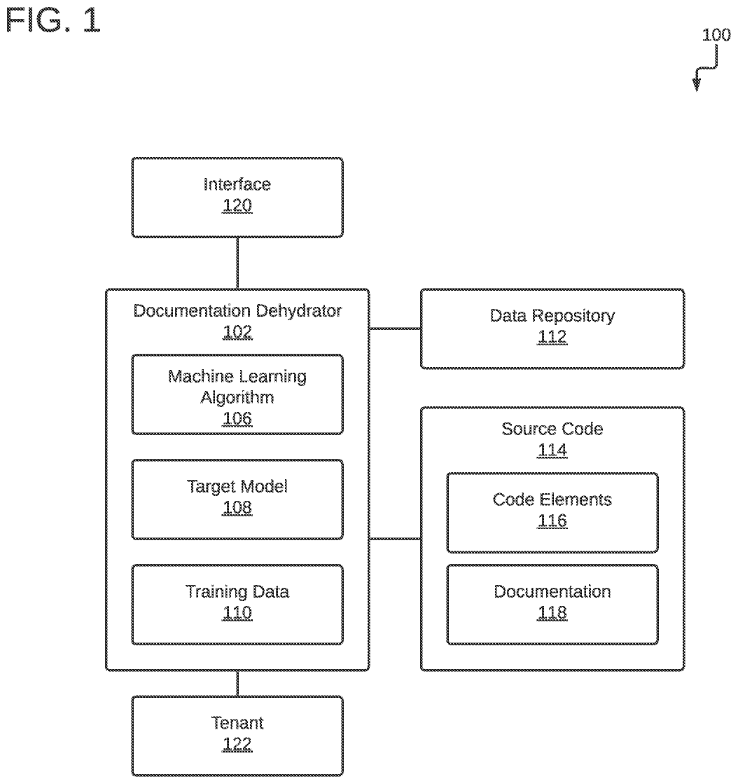

FIG. 1 illustrates an example of a system 100 in accordance with one or more embodiments. As illustrated in FIG. 1, the system 100 includes a document dehydrator 102, a data repository 112, source code 114, an interface 120, and a tenant 122. The document dehydrator 102 includes a machine learning algorithm 106, a target model 108, and training data 110. Each of these components is described in further detail below.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component. Additional embodiments and/or examples relating to computer networks are described below in the section titled “Computer Networks and Cloud Networks.”

In one or more embodiments, a document dehydrator 102 refers to hardware and/or software configured to perform operations for dehydrating hierarchical source code documentation, examples of which are described below. Specifically, the document dehydrator 102 is configured to dehydrate sets of documentation 118 associated with respective code elements 116 (e.g., packages, classes, methods, interfaces, etc.) in a body of source code 114. In FIG. 1, the documentation 118 is illustrated as being stored within the source code 114 itself (e.g., as inline documentation comments). Alternatively, one or more embodiments may store code elements 116 and corresponding documentation 118 separately. The document dehydrator 102 may be configured to use machine learning, one or more string similarity metrics (e.g., one or more distance functions as discussed in further detail below), and/or other techniques to identify repeated segments of text in the documentation 118. Some examples of techniques for identifying repeated segments of text are described below.

In one or more embodiments, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 2.2. Data Storage

In one or more embodiments, a data repository 112 is any type of storage unit and/or device (e.g., a file system, database, collection of tables, and/or any other storage mechanism) for storing data. The data repository 112 may include multiple different storage units and/or devices. The multiple different storage units and/or devices may or may not be of the same type or located at the same physical site. The data repository 112 may be implemented or executed on the same computing system as one or more other components of the system 100 and/or on a computing system separate from one or more other components of the system 100. The data repository 112 may be communicatively coupled to one or more other components of the system 100 via a direct connection or via a network. The data repository 112 may be configured to store any kind of data described herein.

### 2.3. User Interface

In one or more embodiments, an interface 120 refers to hardware and/or software configured to facilitate communications between a user and the document dehydrator 102. The interface 120 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. Different components of the interface 120 may be specified in different languages. For example, the behavior of user interface elements may be specified in a dynamic programming language, such as JavaScript. The content of user interface elements may be specified in a markup language, such as hypertext markup language (HTML) or XML User Interface Language (XUL). The layout of user interface elements may be specified in a style sheet language, such as Cascading Style Sheets (CSS). Alternatively, the interface 120 may be specified in one or more other languages, such as Java, Python, C, or C++.

### 2.4. Tenants

In one or more embodiments, a tenant 122 is a corporation, organization, enterprise, or other entity that accesses a shared computing resource, such as the document dehydrator 102. The system 100 may include multiple tenants 122 that are independent from each other, such that a business or operation of one tenant is separate from a business or operation of another tenant. Some examples of multi-tenant architectures in accordance with one or more embodiments are described in further detail below.

### 2.5. Machine Learning

In one or more embodiments, a machine learning algorithm 106 is an algorithm that can be iterated to learn a target model 108 that best maps a set of input variables to one or more output variables, using a set of training data 110. The training data 110 includes datasets and associated labels. The datasets are associated with input variables for the target model 108. The associated labels are associated with the output variable(s) of the target model 108. For example, the training data 110 may include pairs of segments of text from source code documentation, and a label associated with each pair may indicate a similarity (e.g., using a similarity score) between the two segments of text. The training data 110 may be updated based on, for example, feedback on the accuracy of the current target model 108. Updated training data may be fed back into the machine learning algorithm 106, which may in turn update the target model 108.

The machine learning algorithm 106 may generate the target model 108 such that the target model 108 best fits the datasets of the training data 110 to the labels of the training data 110. Specifically, the machine learning algorithm 106 may generate the target model 108 such that when the target model 108 is applied to the datasets of the training data 110, a maximum number of results determined by the target model 108 match the labels of the training data 110. Different target models may be generated based on different machine learning algorithms and/or different sets of training data.

The machine learning algorithm 106 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 3. Dehydrating Hierarchical Source Code Documentation

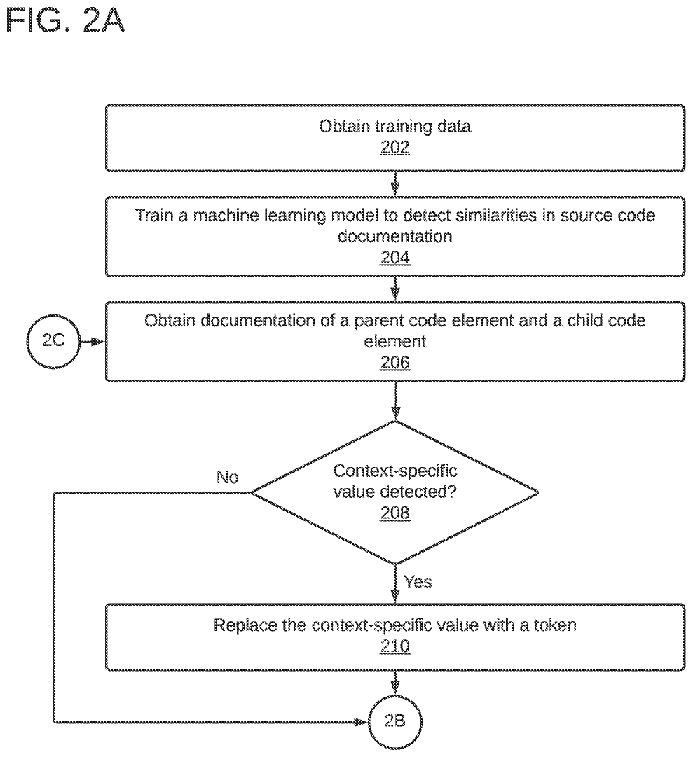

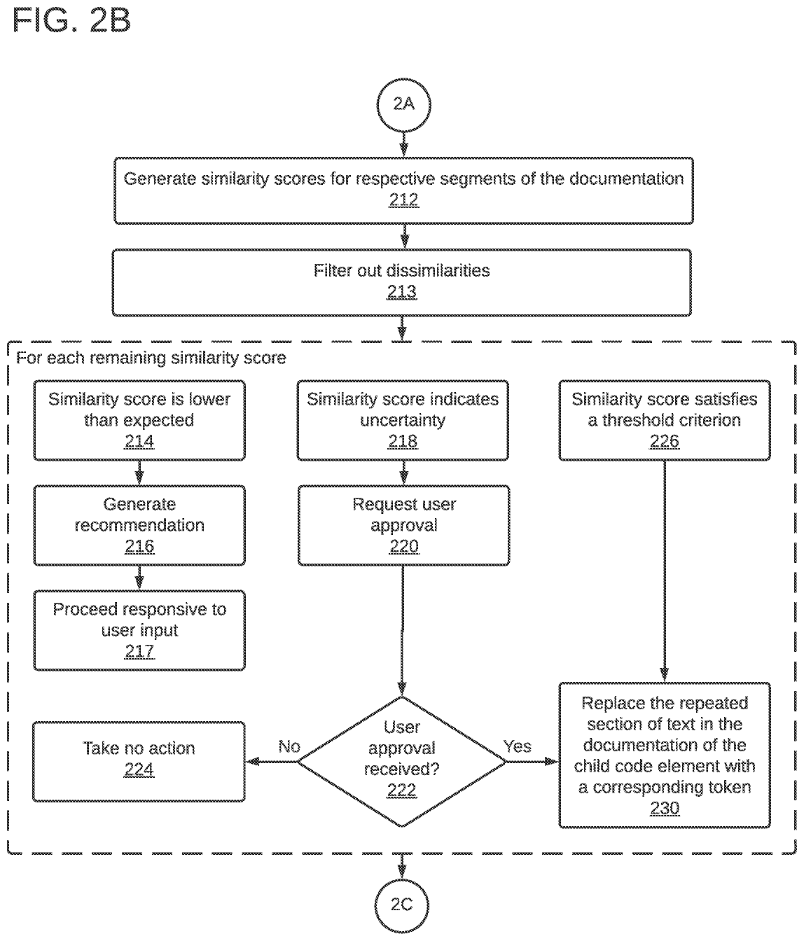

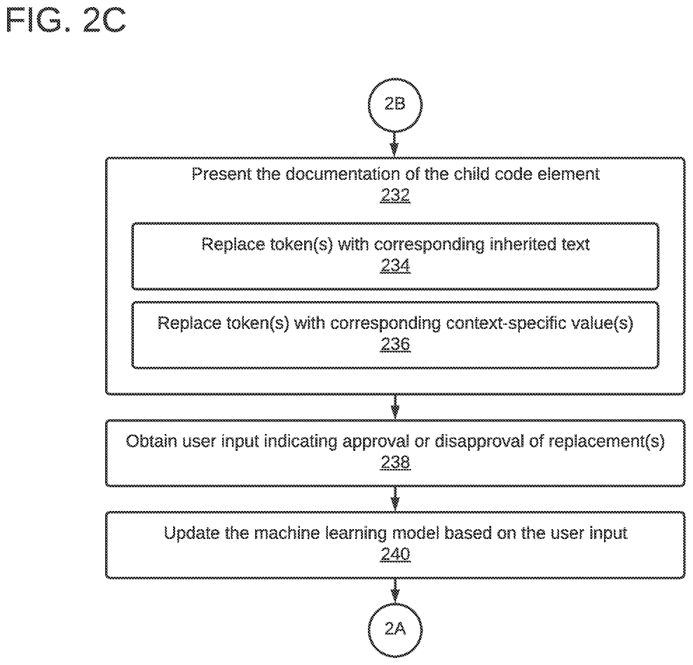

FIGS. 2A-2C illustrate an example set of operations for dehydrating hierarchical source code documentation in accordance with one or more embodiments. One or more operations illustrated in FIGS. 2A-2C may be modified, rearranged, or omitted altogether. Accordingly, the particular sequence of operations illustrated in FIGS. 2A-2C should not be construed as limiting the scope of one or more embodiments.

### 3.1. Training a Machine Learning Model to Detect Similarities in Source Code Documentation

In an embodiment, a system obtains training data (Operation 202). As noted above, the training data may include pairs of segments of text from source code documentation, and a respective label associated with each pair may indicate a similarity (e.g., using a similarity score) between the two segments of text. Using the training data, the system may train a machine learning model to detect similarities in source code documentation (Operation 204). The system may train the machine learning model to generate similarity scores for respective pairs of segments of text, indicating how similar the segments are. Some examples of techniques for machine learning are described in further detail above.

### 3.2. Dehydrating Existing Documentation

In an embodiment, the system obtains documentation associated with at least two elements of code (Operation 206). For example, the system may receive a body of source code that includes inline documentation for multiple code elements (e.g., modules, packages, classes, interfaces, constructors, methods, fields, etc.). At least one of the code elements (referred to herein as the “child” element) inherits functionality from at least one other code element (referred to herein as the “parent” element). For example, the parent element may be an interface and the child element may be a class that implements the interface, the parent element may be a class and the child element may be another class that extends the parent class, etc. The system proceeds to dehydrate the documentation as described below.

### 3.2.1. Context-Specific Values

In an embodiment, the system determines whether the documentation includes a context-specific value (Operation 208). As noted above, a context-specific value may be a package name, interface name, class name, method name, or any other kind of value that depends on its context within the source code and/or source code documentation (e.g., the type and/or scope of the code element described by the documentation). The system may identify context-specific values by parsing the documentation for values that are known to be relevant in that context. Alternatively or additionally, the system may identify context-specific values by comparing segments of text in the documentation and identifying places where the text differs in relatively small amounts; those small differences may signal the presence of context-specific values. For example, the only difference between “Class A produces widgets” and “Class B produces widgets” is the context-specific class name (“A” or “B”).

If the documentation includes a context-specific value, the system may replace the context-specific value with a corresponding token (Operation 210). The token may be a token defined by the system for such purposes (e.g., a system-wide token that references the current package name, interface name, class name, or method name). Alternatively or additionally, the system may support the creation of user-defined tokens, where a user defines a particular token to reference a particular context-specific value. Replacing the context-specific value in the documentation with a token helps ensure that the documentation remains accurate even if the context-specific value changes.

### 3.2.1. Similar Text Segments

In an embodiment, the system is configured to dehydrate the documentation by reducing the amount of repetitive text in the documentation. To help identify repetitive text, the system may generate similarity scores for respective segments of the documentation (Operation 212). The system may use machine learning to identify repetitive text and generate similarity scores. Alternatively or additionally, the system may generate similarity scores using one or more distance functions, such as Levenshtein distance and/or other kinds of distance functions.

The system may generate multiple similarity scores for multiple respective segments of the parent element documentation and the child element documentation. The system may filter out dissimilarities (Operation 213), i.e., segment comparisons having similarity scores that are below a qualification threshold. For example, the system may filter out segment comparisons with similarity scores below 75% or some other predefined threshold metric. The qualification threshold may be user-configurable, to allow for more or less flexibility in identifying repeated text. The system may retain some dissimilarities if they occur in unexpected conditions, as discussed in further detail below.

The system may evaluate each of the remaining similarity score as follows.

### 3.2.1.1. Unexpectedly Low Similarity Score

The system may determine that a particular similarity score is lower than expected (Operation 214). For example, a child element may inherit functionality from a parent element, but have documentation that is considerably different from that of the parent element. This unexpected dissimilarity may indicate an error in the documentation. As another example, the system may determine that multiple child elements inherit functionality from the same parent element, and the documentation of one of the child elements differs substantially from that of the other child elements. This dissimilarity may indicate an error in the documentation of the outlier child element.

Responsive to determining that the similarity score is lower than expected, the system may generate a recommendation to revise the documentation (Operation 216). For example, the system may generate a recommendation suggesting that the child element's documentation be revised to bring it closer in line with the parent element and/or other child elements that inherit the same functionality from the same parent element.

Responsive to generating the recommendation, the system may receive user input indicating approval or disapproval of the recommendation. The system may proceed to handle the recommendation responsive to the user input (Operation 217), for example, by replacing a child element's erroneously dissimilar documentation with a token that references the parent element's documentation.

### 3.2.1.2. Uncertain Similarity Score

The system may determine that a particular similarity score indicates uncertainty as to whether the documentation is similar enough to present an opportunity to reduce repetitive text (Operation 218). For example, the system may evaluate the similarity score against a predetermined threshold criterion (e.g., a minimum similarity score). If the similarity score does not satisfy the threshold criterion, then the system is unable to determine with certainty whether or not the similarity score is associated with a repeated segment of text. Responsive to determining that the similarity score indicates uncertainty, the system may generate a request for user approval to proceed with dehydration (Operation 220). For example, the system may generate an alert that includes the candidate segments of text as found in both the parent element and the child element, and request user input to indicate whether dehydration is appropriate in this instance. The alert interface may also allow for user input to modify either or both segments of text.

If the system receives user approval (Operation 222) (e.g., by receiving user input indicating approval), the system may proceed with reducing repetitive text as described in further detail below. If the system does not receive user approval (e.g., due to lack of response or user input indicating disapproval), the system takes no action (Operation 224) with respect to reducing repetitive text in the documentation segments associated with the similarity score.

### 3.2.1.3. High Similarity Score

The system may determine that a particular similarity score satisfies a threshold criterion for proceeding with reducing repetitive text without requiring user intervention (Operation 226). For example, the system may evaluate the similarity score against a predetermined threshold criterion (e.g., a minimum similarity score). Responsive to determining that the similarity score satisfies the threshold criterion, the system may proceed to reduce repetitive text, as described in further detail below, without requiring user intervention (e.g., without requiring user approval as may be required for uncertain similarity scores as described above).

### 3.2.1.4. Reducing Similar Text

In an embodiment, to reduce similar text, the system replaces the repeated segment of text in the child element's documentation with a corresponding token that references the repeated segment of text in the parent element's documentation (Operation 230). The token may be a token defined by the system for such purposes (e.g., the @inheritDoc token in JavaDoc). Alternatively or additionally, the system may support the creation of user-defined tokens, where a user defines a particular token to reference a particular segment of text from the parent element. Replacing the text in the child element's documentation with a token helps ensure that the documentation remains consistent across parent-child elements, and reduces the amount of space consumed by redundant text.

### 3.3. Presenting Documentation

In an embodiment, the system presents the documentation of the child code element (Operation 232). If the documentation includes any tokens corresponding to similar text in a parent code element, the system replaces the token(s) with the corresponding inherited text (Operation 234). If the documentation includes any tokens corresponding to context-specific values, the system replaces the token(s) with the corresponding context-specific value(s). (Operation 236). In the resulting documentation, all tokens are fully resolved to obtain the full text of the documentation. The system may present the documentation in a CLI, GUI, and/or another kind of interface.

### 3.4. Updating the Machine Learning Model

In an embodiment, the system continues to train the machine learning model on an ongoing basis, based on outcomes of using the machine learning model in practice. The system may obtain user input indicating approval or disapproval of one or more replacements performed by the system (Operation 238). The replacement(s) may include one or more replacements of context-specific values with corresponding tokens and/or one or more replacements of similar text across documentation with corresponding tokens. The user input may indicate, for example, whether each given replacement was accurate or inaccurate. The system may update the machine learning model based on the user input (Operation 240), so that the model is better able to detect and score repeated text in the future, i.e., better than if the model had not been updated responsive to the user input.

### 4. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

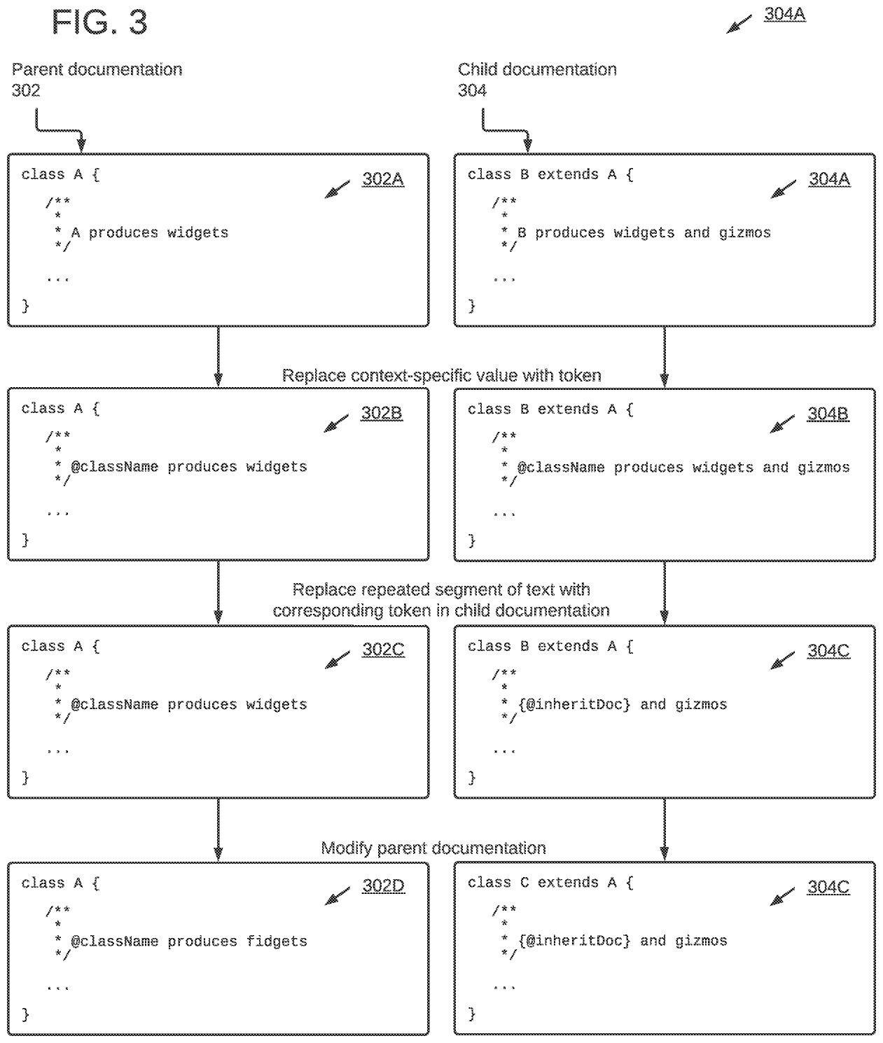

Specifically, FIG. 3 illustrates an example of dehydrating hierarchical source code documentation in accordance with one or more embodiments. In this example, a class A includes documentation 302A indicating that “A produces widgets.” Class B extends A and includes documentation 304A indicating that “B produces widgets and gizmos.”

Both sets of documentation 302A, 304A mention the respective class name A or B. Accordingly, the system can replace the class names with a token that references the context-specific value. In this example, the token is “@className,” but any token may be used so long as the system is configured to recognize it as referencing the context-specific value. The resulting documentation 302B, 304B no longer includes the specific class names.

After replacing the class names with the appropriate token, both sets of documentation 302B, 304B includes the identical text segment “@className produces widgets,” even though the child element's documentation 304B also includes the words “and gizmos.” The system replaces the identical text from the child element's documentation 304B with a token that references the parent element's documentation 302C. In this example, the token used is the “@inheritDoc” functionality provided by JavaDoc (Standard doclet), but any token may be used so long as the system is configured to recognize it as referencing the correct text from parent element's documentation 302C.

In addition to the resulting child element's documentation 304C being shorter than the original documentation 304A, it is also resilient to code changes. For example, in FIG. 3, the class name “B” is changed to “C.” However, the child element's documentation 304C remains accurate because the text segment inherited from the parent element's documentation 302C includes the token for the context-specific value of the class name.

The child element's documentation 304C is also more resilient to changes in the parent element's documentation 302C. In this example, the word “widgets” is a typographical error and needs to be corrected to “fidgets.” However, it is only necessary to revise the parent element's documentation 302C to replace “widgets” with “fidgets.” Because the child element's documentation 302C inherits the text from the parent element's documentation 302D, the change is also reflected in the child element's documentation 304C without needing to change the child element's documentation 304C. When fully resolved, the child element's documentation 304C reads, “C produces fidgets and gizmos.”

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service, such as execution of a particular application and/or storage of a particular amount of data). A server process responds by, for example, executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, or a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network, such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

A client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (for example, a web browser), a program interface, or an application programming interface (API).

In one or more embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

A computer network may implement various deployment, including but not limited to a private cloud, a public cloud, and/or a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof may be accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In a multi-tenant computer network, tenant isolation may be implemented to ensure that the applications and/or data of different tenants are not shared with each other. Various tenant isolation approaches may be used. Each tenant may be associated with a tenant identifier (ID). Each network resource of the multi-tenant computer network may be tagged with a tenant ID. A tenant may be permitted access to a particular network resource only if the tenant and the particular network resources are associated with the same tenant ID.

For example, each application implemented by the computer network may be tagged with a tenant ID, and tenant may be permitted access to a particular application only if the tenant and the particular application are associated with a same tenant ID. Each data structure and/or dataset stored by the computer network may be tagged with a tenant ID, and tenant may be permitted access to a particular data structure and/or dataset only if the tenant and the particular data structure and/or dataset are associated with a same tenant ID. Each database implemented by the computer network may be tagged with a tenant ID, and tenant may be permitted access to data of a particular database only if the tenant and the particular database are associated with the same tenant ID. Each entry in a database implemented by a multi-tenant computer network may be tagged with a tenant ID, and a tenant may be permitted access to a particular entry only if the tenant and the particular entry are associated with the same tenant ID. However, the database may be shared by multiple tenants.

In one or more embodiments, a subscription list indicates which tenants have authorization to access which network resources. For each network resource, a list of tenant IDs of tenants authorized to access the network resource may be stored. A tenant may be permitted access to a particular network resource only if the tenant ID of the tenant is included in the subscription list corresponding to the particular network resource.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted only to other devices within the same tenant overlay network. Encapsulation tunnels may be used to prohibit any transmissions from a source device on a tenant overlay network to devices in other tenant overlay networks. Specifically, packets received from the source device may be encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Microservice Applications

In one or more embodiments, techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally include a single logical executable. With microservice applications, different microservices are independently deployable as separate executables. Microservices may communicate using Hypertext Transfer Protocol (HTTP) messages and/or according to other communication protocols via Application Programming Interface (API) endpoints. Microservices may be managed and updated separately, written in different languages, and executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

Microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### 6.1. Triggers

The techniques described above may be encapsulated into a microservice, according to one or more embodiments. In other words, a microservice may trigger a notification (into the microservices manager for optional use by other plugged-in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects that a value has crossed a triggering threshold.

A trigger, when satisfied, may output data for consumption by the target microservice. Alternatively or additionally, when satisfied, a trigger may output a binary value indicating that the trigger has been satisfied, and/or may output the name of the field or other context information for which the trigger condition was satisfied. Additionally or alternatively. the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 6.2. Actions

A plugged-in microservice application may expose actions to the microservices manager. The exposed actions may receive, as input, data or an identification of a data object or location of data that causes data to be moved into a data cloud.

The exposed actions may receive, as input, a request to increase or decrease existing alert thresholds. The input may identify existing in-application alert thresholds and whether to increase, decrease, or delete the threshold. The input may request the microservice application to create new in-application alert thresholds. The in-application alerts may trigger alerts to the user while logged into the application or may trigger alerts to the user, using default or user-selected alert mechanisms available within the microservice application itself, rather than through other applications plugged into the microservices manager.

The microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. Hardware Overview

In one or more embodiments, techniques described herein are implemented by one or more special-purpose computing devices. The special-purpose computing device(s) may be hard-wired to perform the techniques, and/or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, FPGAs, or NPUs with custom programming to accomplish the techniques. A special-purpose computing device may be desktop computer systems, portable computer systems, handheld devices, networking devices, or any other device that incorporates hard-wired and/or program logic to implement the techniques.

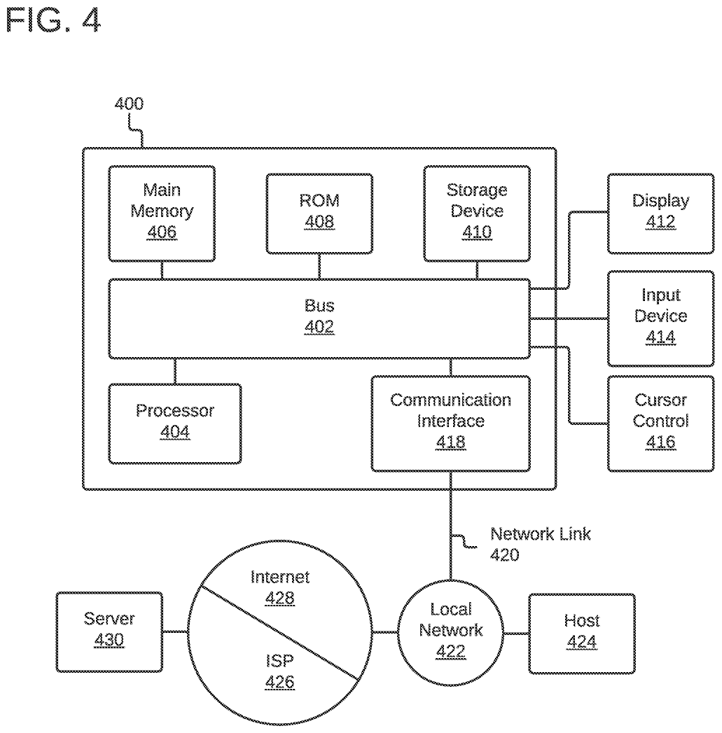

For example, FIG. 4 is a block diagram that illustrates a computer system 400 upon which one or more embodiments of the invention may be implemented. The computer system 400 includes a bus 402 or other communication mechanism for communicating information, and a hardware processor 404 coupled with bus 402 for processing information. The hardware processor 404 may be, for example, a general-purpose microprocessor.

The computer system 400 also includes a main memory 406, such as a random access memory (RAM) or other dynamic storage device, coupled to bus 402 for storing information and instructions to be executed by processor 404. The main memory 406 also may be used for storing temporary variables or other intermediate information during execution of instructions to be executed by processor 404. Such instructions, when stored in non-transitory storage media accessible to the processor 404, render the computer system 400 into a special-purpose machine that is customized to perform the operations specified in the instructions.

The computer system 400 further includes a read only memory (ROM) 408 or other static storage device coupled to the bus 402 for storing static information and instructions for the processor 404. A storage device 410, such as a magnetic disk or optical disk, is provided and coupled to the bus 402 for storing information and instructions.

The computer system 400 may be coupled via the bus 402 to a display 412, such as a cathode ray tube (CRT), for displaying information to a computer user. An input device 414, including alphanumeric and other keys, is coupled to the bus 402 for communicating information and command selections to the processor 404. Another type of user input device is cursor control 416, such as a mouse, a trackball, or cursor direction keys for communicating direction information and command selections to the processor 404 and for controlling cursor movement on the display 412. This input device typically has two degrees of freedom in two axes, a first axis (e.g., x) and a second axis (e.g., y), that allows the device to specify positions in a plane.

The computer system 400 may implement techniques described herein using customized hard-wired logic, one or more ASICs or FPGAs, firmware, and/or program logic which in combination with the computer system 400 causes or programs the computer system 400 to be a special-purpose machine. In one or more embodiments, the techniques herein are performed by the computer system 400 in response to the processor 404 executing one or more sequences of one or more instructions contained in the main memory 406. Such instructions may be read into the main memory 406 from another storage medium, such as the storage device 410. Execution of the sequences of instructions contained in the main memory 406 causes the processor 404 to perform the process steps described herein. Alternatively, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 410. Volatile media includes dynamic memory, such as the main memory 406. Common forms of storage media include, for example, a floppy disk, a flexible disk, hard disk, solid state drive, magnetic tape, or any other magnetic data storage medium, a read-only compact disc (CD-ROM), any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires of the bus 402. Transmission media can also take the form of acoustic or light waves, such as those generated during radio frequency (RF) and infrared data communications.

Various forms of media may be involved in carrying one or more sequences of one or more instructions to the processor 404 for execution. For example, the instructions may initially be carried on a magnetic disk or solid-state drive of a remote computer. The remote computer can load the instructions into its dynamic memory and send the instructions over a telephone line or other communications medium, using a modem. A modem local to the computer system 400 can receive the data on the telephone line or other communications medium and use an infrared transmitter to convert the data to an infrared signal. An infrared detector can receive the data carried in the infrared signal and appropriate circuitry can place the data on the bus 402. The bus 402 carries the data to the main memory 406, from which the processor 404 retrieves and executes the instructions. The instructions received by the main memory 406 may optionally be stored on the storage device 410, either before or after execution by processor 404.

The computer system 400 also includes a communication interface 418 coupled to the bus 402. The communication interface 418 provides a two-way data communication coupling to a network link 420 that is connected to a local network 422. For example, the communication interface 418 may be an integrated services digital network (ISDN) card, cable modem, satellite modem, or a modem to provide a data communication connection to a corresponding type of telephone line. As another example, the communication interface 418 may be a local area network (LAN) card configured to provide a data communication connection to a compatible LAN. Wireless links may also be implemented. In any such implementation, the communication interface 418 sends and receives electrical, electromagnetic, or optical signals that carry digital data streams representing various types of information.

The network link 420 typically provides data communication through one or more networks to other data devices. For example, the network link 420 may provide a connection through a local network 422 to a host computer 424 or to data equipment operated by an Internet Service Provider (ISP) 426. The ISP 426 in turn provides data communication services through the world wide packet data communication network now commonly referred to as the “Internet” 428. The local network 422 and Internet 428 both use electrical, electromagnetic, or optical signals that carry digital data streams. The signals through the various networks and the signals on the network link 420 and through the communication interface 418, which carry the digital data to and from the computer system 400, are example forms of transmission media.

The computer system 400 can send messages and receive data, including program code, through the network(s), network link 420, and communication interface 418. In the Internet example, a server 430 might transmit a requested code for an application program through the Internet 428, ISP 426, local network 422, and communication interface 418.

The received code may be executed by processor 404 as it is received, and/or may be stored in the storage device 410 or other non-volatile storage for later execution.

### 8. Miscellaneous; Extensions

Embodiments are directed to a system with one or more devices that include a hardware processor and that are configured to perform any of the operations described herein and/or recited in any of the claims below.

In one or more embodiments, a non-transitory computer-readable storage medium stores instructions which, when executed by one or more hardware processors, cause performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions which, when executed by one or more hardware processors, cause performance of operations comprising:
obtaining (a) a first set of documentation associated with a first element of source code and (b) a second set of documentation associated with a second element of source code that inherits functionality from the first element of source code;
identifying a repeated segment of text in the first set of documentation and the second set of documentation;
replacing the repeated segment of text in the second set of documentation with a first token that references the repeated segment of text in the first set of documentation;
such that when presenting the second set of documentation, the first token is replaced with the repeated segment of text.

2. The one or more non-transitory computer-readable media of claim 1, the operations further comprising:
storing, in the first set of documentation, a revised version of the repeated segment of text, such that when presenting the second set of documentation, the first token is replaced with the revised version of the repeated segment of text.

3. The one or more non-transitory computer-readable media of claim 1, the operations further comprising:
presenting the second set of documentation, at least by replacing the first token with the repeated segment of text.

4. The one or more non-transitory computer-readable media of claim 3, wherein presenting the second set of documentation further comprises:
replacing, in the second set of documentation, a second token that references a context-specific value with the context-specific value.

5. The one or more non-transitory computer-readable media of claim 4, wherein the context-specific value is one of (a) a name of a module described by the second set of documentation, (b) a name of a package described by the second set of documentation, (c) a name of a class described by the second set of documentation, (d) a name of an interface described by the second set of documentation, (e) a name of a constructor described by the second set of documentation, (f) a name of a method described by the second set of documentation, or (g) a name of a field described by the second set of documentation.

6. The one or more non-transitory computer-readable media of claim 1, wherein identifying the repeated segment of text in the first set of documentation and the second set of documentation comprises:
generating a similarity score for the first set of documentation and the second set of documentation.

7. The one or more non-transitory computer-readable media of claim 6, the operations further comprising:
determining that the similarity score satisfies a threshold criterion;
wherein responsive to determining that the similarity score satisfies the threshold criterion, replacing the repeated segment of text in the second set of documentation with the first token is performed without human intervention.

8. The one or more non-transitory computer-readable media of claim 6, the operations further comprising:
determining that the similarity score does not satisfy a threshold criterion;
wherein responsive to determining that the similarity score does not satisfy the threshold criterion, replacing the repeated segment of text in the second set of documentation with the first token is performed contingent on user approval.

9. The one or more non-transitory computer-readable media of claim 6, wherein generating the similarity score comprises computing a string similarity metric that measures a distance between respective segments of the first set of documentation and the second set of documentation.

10. The one or more non-transitory computer-readable media of claim 1, the operations further comprising:
obtaining (a) a third set of documentation associated with a third element of source code and (b) a fourth set of documentation associated with a fourth element of source code that inherits functionality from the third element of source code;
determining that the fourth set of documentation is dissimilar from the third set of documentation;
responsive to determining that the fourth set of documentation is dissimilar from the third set of documentation: generating a recommendation to incorporate at least part of the third set of documentation into the fourth set of documentation.

11. The one or more non-transitory computer-readable media of claim 1, the operations further comprising;
detecting, in the repeated segment of text, a context-specific value that differs between the first set of documentation and the second set of documentation;
replacing, in the repeated segment of text, the context-specific value with a second token that references the context-specific value.

12. The one or more non-transitory computer-readable media of claim 11, wherein the context-specific value is one of (a) a name of a module described by the second set of documentation, (b) a name of a package described by the second set of documentation, (c) a name of a class described by the second set of documentation, (d) a name of an interface described by the second set of documentation, (e) a name of a constructor described by the second set of documentation, (f) a name of a method described by the second set of documentation, or (g) a name of a field described by the second set of documentation.

13. The one or more non-transitory computer-readable media of claim 1, the operations further comprising:
obtaining a third set of documentation associated with a third element of source code that inherits functionality from the first element of source code;
determining that the third set of documentation lacks the repeated segment of text;
responsive to determining that the third set of documentation lacks the repeated segment of text:
generating a warning that the third set of documentation may be inaccurate.

14. The one or more non-transitory computer-readable media of claim 1, wherein identifying the repeated segment of text in the first set of documentation and the second set of documentation comprises applying a machine learning model to the first set of documentation and the second set of documentation.

15. The one or more non-transitory computer-readable media of claim 14, the operations further comprising:
training the machine learning model to detect similarities in source code documentation.

16. The one or more non-transitory computer-readable media of claim 14, the operations further comprising:
obtaining user input that approves or disapproves replacing the repeated segment of text in the second set of documentation with the first token;
updating the machine learning model based at least on the user input.

17. The one or more non-transitory computer-readable media of claim 1, wherein the first element of source code is in a first class and the second element of source code is in a second class that is a subclass of the first class.

18. The one or more non-transitory computer-readable media of claim 1, wherein the first element of source code is in an interface and the second element of source code is in a class that implements the interface.

19. A system comprising:
one or more hardware processors;
one or more non-transitory computer-readable media; and
program instructions stored on the one or more non-transitory computer readable media which, when executed by the one or more hardware processors, cause the system to perform operations comprising:
obtaining (a) a first set of documentation associated with a first element of source code and (b) a second set of documentation associated with a second element of source code that inherits functionality from the first element of source code;
identifying a repeated segment of text in the first set of documentation and the second set of documentation;
replacing the repeated segment of text in the second set of documentation with a first token that references the repeated segment of text in the first set of documentation;
such that when presenting the second set of documentation, the first token is replaced with the repeated segment of text.

20. A method comprising:
obtaining (a) a first set of documentation associated with a first element of source code and (b) a second set of documentation associated with a second element of source code that inherits functionality from the first element of source code;
identifying a repeated segment of text in the first set of documentation and the second set of documentation;
replacing the repeated segment of text in the second set of documentation with a first token that references the repeated segment of text in the first set of documentation;
such that when presenting the second set of documentation, the first token is replaced with the repeated segment of text;
wherein the method is performed by at least device including a hardware processor.
